(19) United States
(12) Patent Application Publication
(10) Pub. No.: US 2024/0149851 A1
(43) Pub. Date: May 9, 2024

(54) CHECKING AN ACTUAL-PRESSURE SENSOR OF A MOTOR VEHICLE BRAKE SYSTEM

(71) Applicant: ZF CV Systems Global GmbH, Bern (CH)

(72) Inventors: Mirko Brutt, Springe (DE); Matthias Kemmerling, Braunschweig (DE); Tobias Hauschild, Seelze (DE); Ivo Laskawy, Hamburg (DE)

(73) Assignee: ZF CV Systems Global GmbH, Bern (CH)

(21) Appl. No.: 18/493,358

(22) Filed: Oct. 24, 2023

(30) Foreign Application Priority Data
Oct. 28, 2022 (DE) 10 2022 211 503.1

(51) Int. Cl. B60T 13/68; B60T 7/20

(52) U.S. Cl. CPC B60T 13/683; B60T 7/20

(57) ABSTRACT

A method for checking an actual-pressure sensor of a motor vehicle brake system includes establishing the duration of a reaction interval, establishing a threshold value, operating the motor vehicle brake system in an electronic braking mode where the brake system delivers a braking pressure for operation of a trailer brake of a trailer connected to the motor vehicle. The reaction interval starts at the beginning of the braking process and pneumatic actual braking pressure values are measured by means of an actual-pressure sensor, where a starting braking pressure is measured by the actual-pressure sensor at the beginning of a braking process carried out in the electronic braking mode for the trailer. Pneumatic reaction braking pressures are measured within the reaction interval and compared to a threshold value. Brake system operation is discontinued in the electronic operating mode if none of the measured reaction braking pressures exceeds the threshold value.

### RELATED APPLICATIONS

This application claims the benefit of and right of priority under 35 U.S.C. § 119 to German Patent Application no. 10 2022 211 503.1, filed on 28 Oct. 2022, the contents of which are incorporated herein by reference in its entirety.

### FIELD OF THE DISCLOSURE

The invention relates to the checking of an actual-pressure sensor of a motor vehicle brake system.

### SUMMARY

The invention relates in particular to so-termed off-highway vehicles, such as agricultural tractors, which comprise a motor vehicle brake system with an electronic trailer control system. In order to provide a trailer control system of that type with as few sensors as possible, the correct functioning of the electronic trailer control system is typically verified by plausibility checks. Particularly in the case of sensors that measure a pressure of 0 bar for long periods, however, it is difficult for the electronic trailer control system to recognize and to maintain the correct functioning of the electronic trailer control system. Thus, when a desired brake operating pressure is smaller than 1 bar and an actual-pressure sensor measures an actual brake pressure value of 0 bar, the deviation between the desired service brake pressure and the actually measured value is less than 1 bar. The natural reaction of the regulating system is then problematic: since the measured actual braking pressure value is 0 bar, typically it is attempted to reach the desired value by opening the inlet valve of a trailer control valve system. But since the actual-pressure sensor continues to indicate 0 bar, the inlet valve is continuously opened. This results in a sudden increase of the brake pressure and undesired full braking, even though the desired pressure assumes a value of lower than 1 bar.

A purpose of the present invention can be regarded as to improve the regulation of a motor vehicle brake system with an electronic trailer control system in such a way that, in particular, in the event of an incorrectly measuring actual-pressure sensor, full braking is prevented. This objective is achieved by embodiments disclosed in the claims, the description, and the figures.

According to the present invention, a plausibility check to recognize an incorrectly functioning outlet pressure sensor (“actual-pressure sensor” in what follows) is proposed. The invention describes a special plausibility check for the prompt recognition of a defective function of the actual-pressure sensor. The plausibility check described relates to a sensor defect or a system defect that results in a pressure measurement value of 0 bar by the actual-pressure sensor. The idea is that at the beginning of every braking operation carried out by virtue of an electronic trailer braking mode, a specially developed plausibility check is initiated. In the electronic braking mode the braking of the motor vehicle, and in the present case also the braking of the trailer, takes place only indirectly, whereby a far-reaching electronic regulation of the braking power by driver assistance systems, such as an anti-blocking system or a starting regulator, is made possible. In particular, this electronic regulation enables precise adjustment of the braking performance so as to achieve effective braking of the motor vehicle that is appropriate for the situation. The actual braking pressure values measured by the actual-pressure sensor constitute an important input parameter for the further regulation of the brake system of the motor vehicle. The plausibility check is intended to confirm whether a minimum outlet pressure at the actual-pressure sensor, in particular as the result of multiple inlet valve actuations, is reached within a predetermined time. If the minimum outlet pressure is not reached within the predetermined time, then the system automatically switches off the electronic trailer braking control and can, in particular, change to a mechanical redundancy mode in order to avoid the over-braking of the trailer described above.

In this sense, according to a first aspect of the invention, a method for checking an actual-pressure sensor of a motor vehicle braking system is provided. The method comprises in particular the following process steps:
(100): establishing a time duration of a reaction interval,
(200): establishing a threshold value, in particular a pneumatic or a hydraulic threshold value,
(300): operating a motor vehicle brake system of a motor vehicle in an electronic braking mode, wherein the motor vehicle brake system delivers to a trailer connected to the motor vehicle a brake pressure (in particular a pneumatic or hydraulic brake pressure), so that a trailer braking system of the trailer can be actuated by means of the said brake pressure,
(400): starting the reaction interval at the beginning of the braking process and measuring actual braking pressure values (in particular pneumatic or hydraulic actual braking pressure values) by means of an actual-pressure sensor, so that a starting brake pressure of the motor vehicle brake system is measured by means of the actual-pressure sensor at the beginning of a braking operation which is carried out in the electronic braking mode for the trailer,
(500): measuring of reaction brake pressures, in particular pneumatic or hydraulic reaction brake pressures, within the reaction interval by means of the actual-pressure sensor,
(600): checking whether the reaction brake pressures exceed the threshold value, wherein
(600a): the operation of the motor vehicle brake system in the electronic operating mode is continued if at least one reaction brake pressure exceeds the threshold value, and
(600b): the operation of the motor vehicle brake system in the electronic operating mode is discontinued if none of the reaction brake pressures exceeds the threshold value.

The distinguishing feature of the method according to the invention is that no additional actual-pressure sensor is needed for the plausibility check. Furthermore, the driver of the motor vehicle does not recognize or notice the plausibility check, since it takes place in the background. In addition, an early recognition of a fault enables the initiation of the system reaction, so that unintentional full braking is prevented, in particular including a warning to the driver.

The process steps (400) to (600) can be carried out with every braking process which is initiated when the motor vehicle brake system is operating in the electronic braking mode. In that way a particularly high safety standard can be achieved. On the other hand, computation time can be saved, since in particular the process steps (500) and (600) are only carried out when in process step (400) the value 0 bar is measured as the starting brake pressure. Alternatively, it can be provided that the process steps (500) and (600) are only carried out if in process step (400) a starting pressure between 0 bar and the established threshold value is measured.

For the in particular pneumatic or hydraulic brake pressure, according to an embodiment, a target value is established which is not in excess of 1 bar, such that the brake pressure is regulated on the basis of the established target value for the brake pressure and on the basis of the actual brake pressure value measured by the actual-pressure sensor. Thus, the method according to the invention can be used in particular for gentle braking demands, for which no test has hitherto been known from the prior art. The threshold value can in particular be established at a value between 0 bar and the target value of the brake pressure. The reaction interval can for example be set with a duration between 50 milliseconds and 300 milliseconds.

The motor vehicle brake system can comprise in particular an electro-pneumatic trailer control valve system with an inlet valve. By means of the inlet valve the output pressure of the motor vehicle brake system can be regulated, since the inlet valve is moved to an open position in order to increase the output pressure. In this connection one can speak of a pulse which increases the output pressure or the pneumatic braking pressure. The inlet valve can also be returned again to a closed position in order to prevent an increase of the output pressure, or at least to reduce it. By the extent to which the inlet valve is opened, the intensity of the pressure increase can further be varied. Thus, if the inlet valve is opened wider, then as a rule the pressure increase is more rapid than with a narrower opening. In particular, the inlet valve can be moved to the open and closed condition multiple times within the reaction interval. According to an embodiment, in this sense it is provided that the inlet valve is opened at least once within the reaction interval in order to increase the braking pressure of the motor vehicle brake system in such manner that the measured reaction braking pressure exceeds the threshold value. For this, the trailer control valve system can be directed by an electronic control unit. The inlet valve can also be opened in such manner that not only is the threshold value, but instead a service brake pressure required or desired for the braking process is exceeded.

The pressure regulation can in particular take place in such manner that the pneumatic braking pressure is increased “cautiously” to a desired service brake pressure below 1 bar, for example, to 0.5 bar, without exceeding that target pressure. For that purpose, the inlet valve can, for example, not be opened completely, but only partially. This cautious pressure regulation could have the result that the minimum pneumatic pressure is not exceeded within the reaction interval and the test fails because the regulation process is too slow. To guard against that, the pressure regulation process is adjusted in such manner that an initial opening pulse of the inlet valve of the trailer control valve system is artificially prolonged in order to compel the reaction pressures to reach a particular value, in particular the pneumatic threshold value, more rapidly. In that sense, according to an embodiment it is provided that the inlet valve is moved to an open condition several times within the reaction interval, so that when the inlet valve is moved to the open condition for the first time it remains open for longer than when it is moved to the open condition again after the first time. At the beginning of the reaction interval this results in a very small pressure peak during the time variation of the pneumatic brake pressure. That pressure peak is small enough not to overshoot the desired service brake pressure. Instead, the pressure peak signals to the control unit software within the reaction interval that the actual-pressure sensor will not remain at 0 bar, but it is capable of providing correct values.

Furthermore, it is possible to increase the scope of diagnosis. The plausibility check described above is carried out during a braking demand by the driver. This leads to a high degree of diagnosis cover, but a system-fault or sensor-fault function is only recognized at the beginning of the braking process. To alert the driver to reduced performance, it could be helpful to check the sensor performance before the braking operation. Since the pressure peaks can be very small (for example˜100 mbar), it is possible to trigger a single high inlet valve pulse even when there is no braking demand. In that sense, according to an embodiment it is provided that the inlet valve is moved once to an open condition while no braking operation is being carried out, so that a pressure peak occurs in the time variation of the brake pressure while no braking process is in progress.

The inlet valve pulse can in particular be followed by an outlet valve pulse, so that the said short pressure increase has no effect on the brake pressure of the trailer, but it is nevertheless possible to perceive a value at the actual pressure sensor. In that case, the sensor can be classified as “OK” and the system remains in normal operation. In that sense, according to an embodiment it is provided that, in particular, the electro-pneumatic trailer control valve system comprises an outlet valve, so that the inlet valve is moved to a closed condition after having previously been moved to the open condition while no braking operation is in progress, so that the pressure peak is counteracted. The advantage of this strategy consists in the continuous use of this “test pulse” (slight pressure increase by way of the inlet valve) while the vehicle is at rest or while it is driving. With this solution the degree of diagnosis cover is even greater and faults are recognized already before a braking process. With this type of checking it is also advantageous for the actual-pressure sensor to be located close to the source from which the pressure is produced. In that way the possibility that the sensor does not perceive the effect of the brief impulse can be avoided. With this in mind, according to an embodiment it is provided that the actual-pressure sensor is arranged close to the inlet valve.

According to a second aspect of the invention, a motor vehicle is provided. The motor vehicle comprises a motor vehicle brake system with an electronic control unit. The motor vehicle brake system is designed to be operated in an electronic braking mode, wherein the motor vehicle brake system delivers to a trailer connected to the motor vehicle an in particular pneumatic or hydraulic brake pressure so that a trailer brake system of the trailer can be actuated by means of the said brake pressure. The electronic control unit is designed in particular to implement the process steps (400) to (600) in accordance with a method according to the first aspect of the invention. The motor vehicle is in particular an off-highway vehicle. An off-highway vehicle is understood to be a vehicle which can be operated at least predominantly away from roads. Basically, the vehicle can be any vehicle that does not run on rails. It can be an articulated or semitrailer vehicle. The vehicle can have a trailer. For example, such a vehicle with a trailer can be in the form of a tractor-trailer combination, a truck train, or a semitrailer truck. The tractor-trailer combination can, for example, be an agricultural machine (tractor) with a trailer. The vehicle can also be a dumper, a towing vehicle, or a truck.

### BRIEF DESCRIPTION OF THE DRAWINGS

Below, example embodiments of the invention are explained in greater detail with reference to the schematic drawing, wherein the same or similar elements are denoted by the same indexes and which shows:

FIG. 1: a motor vehicle to which a trailer is coupled,

FIG. 2: details of a motor vehicle brake system for the motor vehicle in FIG. 1,

FIG. 3: a pressure/time diagram with an output pressure of the motor vehicle brake system in FIG. 2, which increases with time,

FIG. 4: a working sequence diagram of an example embodiment of a method according to the invention for checking an actual-pressure sensor of the motor vehicle brake system in FIG. 2,

FIG. 5: a bar chart with opening times of an inlet valve of the motor vehicle brake system in FIG. 2, for increasing its output pressure, and

FIG. 6: a pressure/time diagram with an output pressure of the motor vehicle brake system in FIG. 2 that is increasing over time due to the opening times of the inlet valve as shown in FIG. 5.

### DETAILED DESCRIPTION

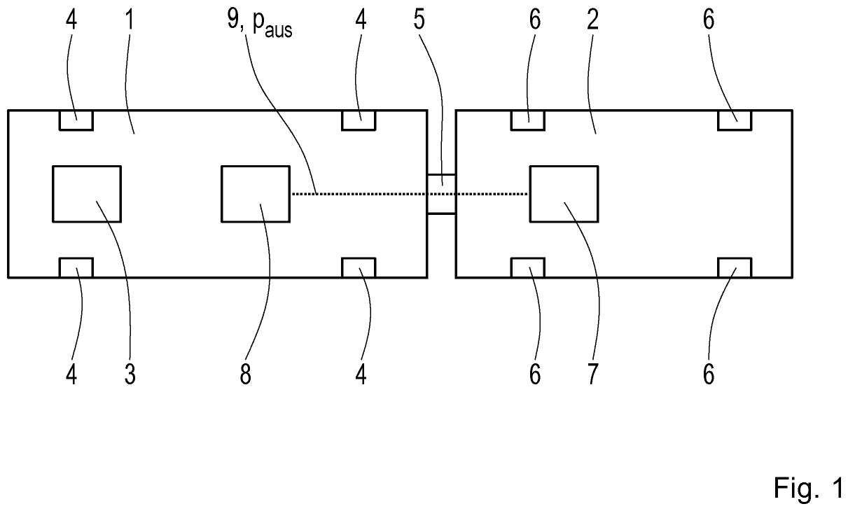

FIG. 1 shows a motor vehicle 1 and a trailer 2. The motor vehicle is, for example, an agricultural utility vehicle, in particular a tractor. The motor vehicle has a motor 3 for driving wheels 4 of the motor vehicle 1. The trailer 2 does not have a motor. The motor vehicle 1 also has a trailer coupling 5 by means of which the motor vehicle 1 and the trailer 2 are mechanically coupled to one another, so that the motor vehicle 1 can in particular tow the trailer 2. In the example embodiment shown, the trailer 2 rolls on four wheels 6 (or wheel pairs). At least one of those wheels 6 can be braked and brought to a standstill by a trailer brake system 7 of the trailer 2.

The motor vehicle 1 has a motor vehicle brake system 8. The motor vehicle brake system 8 is connected to the trailer brake system 7 by way of a compressed-air line 9 (the “trailer control line”). The term “connected” is in particular understood to mean that the elements respectively connected to one another are pneumatically linked with one another, i.e., that a pneumatic pressure medium, in particular compressed air, is supplied under pressure by one element and can act on or in the other element. In the example embodiment shown, the motor vehicle brake system 8 produces a pneumatic brake pressure pₐᵤₛ which is delivered via the compressed-air line 9 to the brake system 7 of the trailer, which uses the pneumatic brake pressure paus to brake the wheels 6. Thus, the compressed-air line 9 serves for the pressure control of the trailer's brake system 7 and can therefore be regarded as the trailer control line.

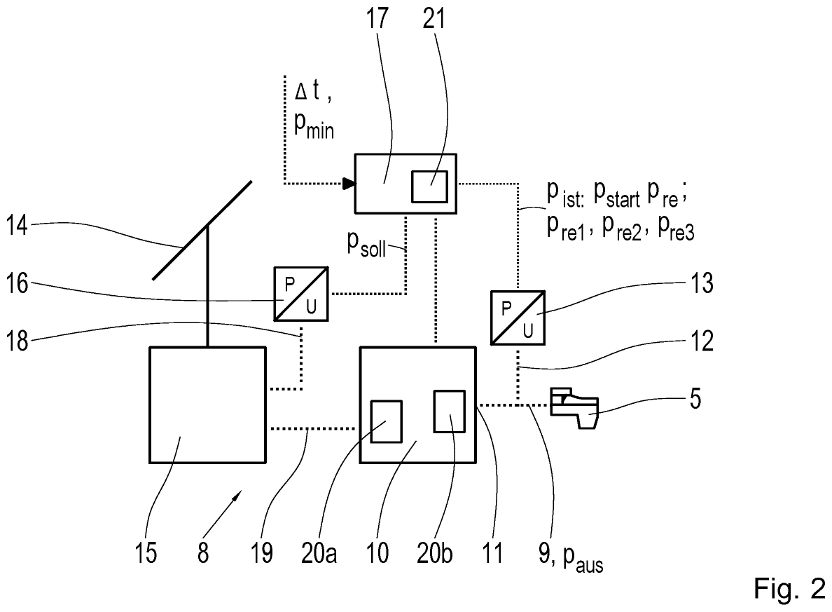

FIG. 2 shows some details of the motor vehicle brake system 8 according to FIG. 1. The motor vehicle brake system 8 comprises an electro-pneumatic trailer control valve 10 (eTCV). A pressure outlet 11 of the trailer control valve system 10 is connected to the compressed-air line 9. To the pressure outlet is applied the pneumatic brake pressure paus, which corresponds to a set pressure level of the motor vehicle brake system 8. From the compressed-air line 9 a measurement line 12 branches off, which leads to an actual-pressure sensor 13. In addition, in the example embodiment shown the motor vehicle brake system 8 comprises a foot pedal 14, a foot-brake valve 15 (FBV), a required-pressure sensor 16, and an electronic control unit 17 (ECU).

A driver of the motor vehicle 1 (not shown) can actuate the foot pedal 14 with his foot, which pedal is connected to the foot-brake valve 15. Depending on the actuation intensity of the foot pedal 14, the foot-brake valve 15 produces a control pressure for the motor vehicle brake system 8. In the example embodiment shown, the motor vehicle brake system 8 comprises two independent control circuits 18 and 19. Alternatively, only one control circuit can be provided, which is then connected to the trailer control valve 10 and the required-pressure sensor 16.

The required-pressure sensor 16 conveys electronically the value of a desired service brake pressure pₛₒₗₗ (the desired value of the pneumatic brake pressure pₐᵤₛ) called for by the driver by way of the foot pedal 14, to the electronic control unit 17. On the basis of the service brake pressure pₛₒₗₗ required and the actual brake pressure values (pᵢₛₜ) measured by the actual-pressure sensor 13, the electronic control unit 17 regulates the output pressure pₐᵤₛ of the electronically controlled trailer control valve system 10. For that purpose, the trailer control valve system 10 that acts in a closed control circuit with the actual-pressure sensor 13 can comprise an inlet valve 20a and an outlet valve 20b. The actual brake pressure value pᵢₛₜ measured by the actual-pressure sensor 13 is conveyed electronically to the electronic control unit 17. Thus, the electronic control unit 17 can access the actual brake pressure value pᵢₛₜ measured by the actual-pressure sensor 13 and the desired brake pressure value pₛₒₗₗ determined by the required-pressure sensor 16. The actual pressure value pᵢₛₜ measured by the actual-pressure sensor 13 can then be linked with the desired service brake pressure pₛₒₗₗ by way of a braking characteristic diagram 21 stored in the electronic control unit 17.

The motor vehicle brake system 8 can be operated in an electronic braking mode, in accordance with which a service brake pressure pₛₒₗₗ desired by the driver is automatically regulated, so that the output pressure pₐᵤₛ is produced in the compressed-air line 9. In that case the driver does not have to intervene in the regulating process. The actual brake pressure value pᵢₛₜ detected by the actual-pressure sensor 13 normally corresponds to the output pressure pₐᵤₛ. Now and then, however, it can happen that the actual-pressure sensor 13 measures an actual pressure value of 0 bar and/or conveys it to the electronic control unit 17. This can be attributed to a defect of the actual-pressure sensor 13 itself, or to a defect in the connection, in particular the measurement line 12, between the actual-pressure sensor 13 and the output pressure pₐᵤₛ.

In that event the cases described below can be distinguished. In a first case the desired service brake pressure pₛₒₗₗ can be greater than 1 bar. If the actual-pressure sensor 13 measures an actual brake pressure value of 0 bar and conveys that to the electronic control unit 17, then the difference between the desired service brake pressure pₛₒₗₗ and the value actually measured is larger than 1 bar. In such a case, known plausibility checks stored in the electronic control unit 17 can recognize a functional fault, the trailer control valve system 10 is brought to a mechanical redundancy mode, and the electronic braking mode is switched off.

In a second case, for the pneumatic brake pressure pₐᵤₛ, a target value pₛₒₗₗ can be established, which is not greater than 1 bar. If the actual-pressure sensor 13 measures an actual brake pressure value of 0 bar and conveys that to the electronic control unit 17, then the difference between the desired service brake pressure pₛₒₗₗ and the value actually measured is less than 1 bar. In that case, in systems known from the prior art, no plausibility check is available. The natural reaction of the regulating system then poses a problem: since the measured actual brake pressure value pᵢₛₜ is 0 bar, the electronic control unit 17 tries to reach the target value pₛₒₗₗ, typically by opening the inlet valve 20a of the trailer control valve 10. But since the actual-pressure sensor 13 still indicates 0 bar, the inlet valve 20a also remains continually open. This results in a sudden increase of the pneumatic brake pressure pₐᵤₛ in the trailer control line 9 and an undesired full braking, even though the target pressure pₛₒₗₗ has a value below 1 bar.

In order to provide a solution for the second case group described, namely (pₛₒₗₗ<=1 bar; pᵢₛₜ=0 bar), a plausibility check is carried out which relates to a defect of the actual-pressure sensor 13 or a system defect that results in an actual brake pressure value of pᵢₛₜ=0 bar at the actual-pressure sensor 13. In this case the plausibility check is in particular carried out at each beginning of a braking operation carried out in the electronic trailer braking mode. The plausibility check is intended to confirm whether a minimum output pressure pₘᵢₙ (threshold value) at the actual-pressure sensor 13 has been reached as a result of multiple actuations of the inlet valve 20a within a predetermined time tₘₐₓ. If the minimum output pressure pₘᵢₙ has not been reached within the predetermined time tₘₐₓ, then the motor vehicle brake system 8 automatically switches off the electronic trailer control system and changes to a mechanical redundancy mode in order to avoid the above-mentioned over-braking of the trailer 2.

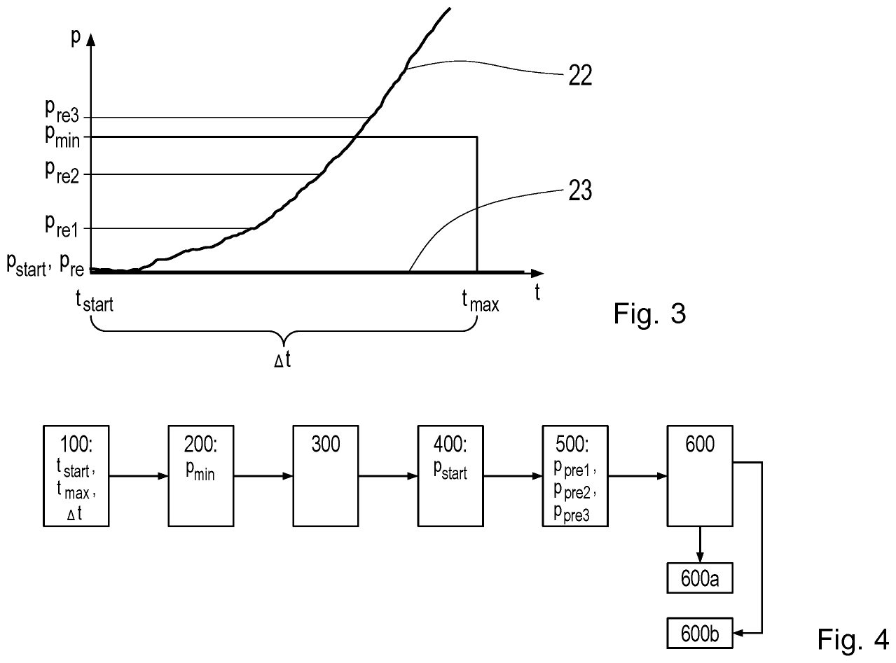

FIGS. 3 and 4 show how a corresponding method for checking the actual-pressure sensor 13 of the motor vehicle brake system 8 can proceed. In a first process step 100 a timed reaction interval Δt is established. For example, the timed reaction interval Δt is stored in a memory of the electronic control unit 17, for example, by way of a man-machine interface designed for the purpose. The reaction interval Δt is a time period that begins at the starting time point tₛₜₐᵣₜ when a braking operation is initiated by the motor vehicle brake system 8 while the motor vehicle brake system 8 is being operated in its electronic braking mode. The beginning of the braking process can be taken to be, for example, the actuation of the foot pedal 14 by the driver. Alternatively, for example, it can also be taken as the electronic conveying of the desired service brake pressure pₛₒₗₗ to the electronic control unit 17 by the required-pressure sensor 16. The reaction interval Δt ends at a set end time point tₘₐₓ, which is also established during the step 100. Thus, the reaction interval Δt is obtained as the difference between the set end time point tₘₐₓ and the starting time point tₛₜₐᵣₜ (Δt=tₘₐₓ−tₛₜₐᵣₜ). The reaction interval Δt can in particular be established once and for all for a number of braking operations and can be stored, for example, in the electronic control unit 17. If needs be, the value of the reaction interval Δt can be changed. Furthermore, the reaction interval Δt can have several different values, for different braking modes. In particular, the reaction interval Δt does not have to be established for each braking operation.

In a second process step 200, a pneumatic threshold value pₘᵢₙ is established. For example, the pneumatic threshold value pₘᵢₙ can be stored in the memory of the electronic control unit 17, for example, by way of the above-mentioned man-machine interface. As shown in FIG. 4, the second process step 200 can take place after the first process step 100. Alternatively, the first and second process steps 100 and 200 can take place simultaneously or, however, the second process step 200 can take place before the first process step 100. The threshold for the threshold value pₘᵢₙ can be chosen at a very low pressure level, in order to recognize the defect as early as possible. In this case the threshold value pₘᵢₙ is not chosen higher than the desired service brake pressure, i.e., in particular no higher than 1 bar. Similar to the reaction interval Δt, the threshold value pₘᵢₙ can in particular be established once and for all for a plurality of braking operations and, for example, stored in the electronic control unit 17. If necessary, the value of the threshold value pₘᵢₙ can be changed. Furthermore, the threshold value pₘᵢₙ can have several different values for different kinds of braking. In particular, the threshold value pₘᵢₙ does not have to be established for every braking operation.

In a third process step 300, as described earlier the motor vehicle brake system 8 is operated in the electronic braking mode, wherein the motor vehicle brake system 8 delivers the pneumatic braking pressure pₐᵤₛ to the trailer 2 connected to the motor vehicle 1, so that the trailer brake system 7 can be actuated by means of the pneumatic braking pressure pₐᵤₛ, or so that the trailer brake system 7 can use the pneumatic breaking pressure pₐᵤₛ for its actuation.

When the driver of the motor vehicle initiates a braking operation by actuating the foot pedal 14, the required-pressure sensor 16 communicates the corresponding desired service brake pressure pₛₒₗₗ to the electronic control unit 17, and this can be regarded as the starting time tₛₜₐᵣₜ. The desired service brake pressure pₛₒₗₗ adopts a value which is lower than 1 bar, for example 0.7 bar. The threshold value pₘᵢₙ can be set, for example, at a value of 0.2 bar (second process step 200). The reaction interval Δt can be set, for example, at a duration of 150 milliseconds. In a fourth process step 400, at the starting time tₛₜₐᵣₜ a pneumatic starting brake pressure pₛₜₐᵣₜ of the motor vehicle brake system 8 is then measured by the actual-pressure sensor 13. Moreover, the value of the measured pneumatic starting brake pressure pₛₜₐᵣₜ can be conveyed electronically to the electronic control unit 17. In addition, in the fourth process step 400 the reaction interval Δt is started at the starting time tₛₜₐᵣₜ.

FIG. 3 shows by a first graph 22 (“fault-free” checking, since the pressure pₘᵢₙ is reached before the time point tₘₐₓ) the time variation of the pneumatic braking pressure pₐᵤₛ measured by the actual-pressure sensor 13. This first graph starts at the zero-point of the coordinate system and has an essentially exponential shape. According to the first graph 22, at the starting time tₛₜₐᵣₜ the value 0 bar is measured as the pneumatic starting brake pressure pₛₜₐᵣₜ (process step 400). In that case, in the sense of a plausibility check it is checked whether the value 0 bar is plausible, or whether there is a defect, particularly in the actual-pressure sensor 13. For that purpose, in a fifth process step 500 a plurality of pneumatic reaction braking pressures within the reaction interval Δt are measured by the actual-pressure sensor 13. In FIG. 3, purely as an example three such reaction pressures pᵣₑ₁, pᵣₑ₂, pᵣₑ₃ are shown. When the reaction interval Δt has ended, i.e., aftertime point tₘₐₓ, no more reaction braking pressures have to be measured for the plausibility check.

In a sixth process step 600 it is checked whether the reaction braking pressures pᵣₑ₁, pᵣₑ₂, pᵣₑ₃ exceed the minimum pneumatic pressure pₘᵢₙ. In the example shown in FIG. 3, the measured actual braking pressure pᵢₛₜ varies in such manner that a first reaction pressure value pᵣₑ₁ and a second reaction pressure value pᵣₑ₂ have values lower than the minimum pneumatic pressure pₘᵢₙ.

In this case the first reaction braking pressure pᵣₑ₁ is above the pneumatic starting brake pressure pₛₜₐᵣₜ (0 bar). The electronic control unit 17 has previously compared the value of the pneumatic braking pressure pₐᵤₛ (0 bar), measured by the actual-pressure sensor 13 and sent to the electronic control unit 17, with the desired service brake pressure pₛₒₗₗ=0.7 bar. To increase the pneumatic braking pressure pₐᵤₛ to the desired service brake pressure pₛₒₗₗ, the electronic control unit 17 has directed the trailer control valve 10 system to move its inlet valve 20a to an open condition. As shown by the first graph 22, by this opening of the inlet valve 20a the pneumatic braking pressure pₐᵤₛ has increased in such manner that the measured first reaction braking pressure pᵣₑ₁ is higher than the pneumatic starting brake pressure pₛₜₐᵣₜ (0 bar). However, the minimum pneumatic pressure pₘᵢₙ does not exceed the first reaction braking pressure pᵣₑ₁.

As shown by the first graph 22, the second reaction braking pressure pᵣₑ₂ is higher than the first reaction braking pressure pᵣₑ₁. The electronic control unit 17 has previously compared the value of the first reaction braking pressure pᵣₑ₁, measured by the actual-pressure sensor 13 and sent to the electronic control unit 17, with the desired service brake pressure pₛₒₗₗ, which has not yet been reached. To increase the pneumatic braking pressure pₐᵤₛ to the desired service brake pressure pₛₒₗₗ, the electronic control unit 17 has directed the trailer control valve system 10 to move its inlet valve 20a to the open condition or to leave it in the open condition. As shown by the first graph 22, by this opening of the inlet valve 20a the pneumatic braking pressure pₐᵤₛ has increased in such manner that the measured second reaction braking pressure pᵣₑ₂ is higher than the first reaction braking pressure pᵣₑ₁. However, the second reaction braking pressure pᵣₑ₂ still does not exceed the minimum pneumatic pressure pₘᵢₙ.

However, the third reaction braking pressure pᵣₑ₃ located within the reaction interval Δt adopts a value that does exceed the minimum pneumatic pressure pₘᵢₙ. The electronic control unit 17 has previously compared the value of the second reaction braking pressure pᵣₑ₂, measured by the actual-pressure sensor 13 and sent to the electronic control unit 17, with the desired service brake pressure pₛₒₗₗ=0.7 bar, which has not yet been reached. To increase the pneumatic braking pressure pₐᵤₛ to the desired service brake pressure pₛₒₗₗ, the electronic control unit 17 has directed the trailer control valve system 10 to move its inlet valve 20a to the open condition or to leave it in the open condition. As shown by the first graph 22, by this opening of the inlet valve 20a, the pneumatic braking pressure pₐᵤₛ has increased in such manner that the measured third reaction braking pressure pᵣₑ₃ is now higher than the minimum pneumatic pressure pₘᵢₙ. Thus, the check in process step 600 shows that at least one measured reaction braking pressure, namely, the third measured reaction braking pressure pᵣₑ₃, is higher than the minimum pneumatic pressure pₘᵢₙ. On that basis it can be concluded that the actual-pressure sensor 13 has measured the value 0 bar for the pneumatic starting pressure correctly and is not defective. Consequently, the operation of the motor vehicle brake system 8 in accordance with a process step 600a in the electronic braking mode is continued (Alternative 1).

FIG. 3 shows by virtue of a second graph 23 (“stuck at zero”; the actual-pressure sensor 13 constantly shows 0 bar and the system check fails, since pₘᵢₙ is not reached, in particular before time-point tₘₐₓ), an alternative time variation of the pneumatic braking pressure pₐᵤₛ measured by the actual-pressure sensor 13. The second graph 23 begins at the zero-point of the coordinate system and remains horizontal. Thus, according to this second graph 23 at the starting time-point tₛₜₐᵣₜ the value 0 bar is measured as the pneumatic starting brake pressure pₛₜₐᵣₜ (process step 400). In this case, in the sense of a plausibility check it is checked whether the value 0 bar is plausible or whether there is a fault, particularly in the actual-pressure sensor 13. For that purpose, in the fifth process step 500 a plurality of pneumatic reaction braking pressures pre are measured by the actual-pressure sensor 13 within the reaction interval Δt. The second graph 23 runs horizontally, so that all the measured reaction braking pressures pre adopt the value 0 bar. This means that the actual-pressure sensor 13 is continually measuring a pneumatic braking pressure pₐᵤₛ of 0 bar. When the reaction interval Δt has ended, i.e., after time-point tₘₐₓ, no more reaction braking pressures have to be measured for the plausibility check.

In the sixth process step 600 it is checked whether the reaction braking pressures pre exceed the minimum pneumatic pressure pₘᵢₙ. Since none of the reaction braking pressures pre gets above the value 0 bar, the check shows that none of the measured reaction braking pressures pre exceed the minimum pneumatic pressure pₘᵢₙ. On this basis it can be concluded that the actual-pressure sensor 13 has measured the value 0 bar for the pneumatic starting brake pressure pₛₜₐᵣₜ incorrectly and is therefore defective. Consequently, in a process step 600b the operation of the motor vehicle brake system 8 in its electronic operating mode is discontinued (Alternative 2). Instead, from that time-point onward the motor vehicle brake system 8 can be operated in the mechanical redundancy mode already mentioned earlier.

For the above-described type of checking, special prerequisites and settings of the pressure regulation may be required. With a desired service brake pressure pₛₒₗₗ of 0.5 bar, for example, the control system increases the pressure “cautiously” to the desired value pₛₒₗₗ and the attempt is made not to exceed that desired value pₛₒₗₗ. That would normally result in the minimum pneumatic pressure pₘᵢₙ not being exceeded within the reaction interval Δt and the test would then fail because the regulation process is too slow. Accordingly, the pressure regulation is adjusted in such manner that the initial opening pulse of the inlet valve 20a of the trailer control valve system 10 is artificially prolonged in order to compel the reaction pressures to reach a particular value, specifically the pneumatic threshold value pₘᵢₙ, more quickly.

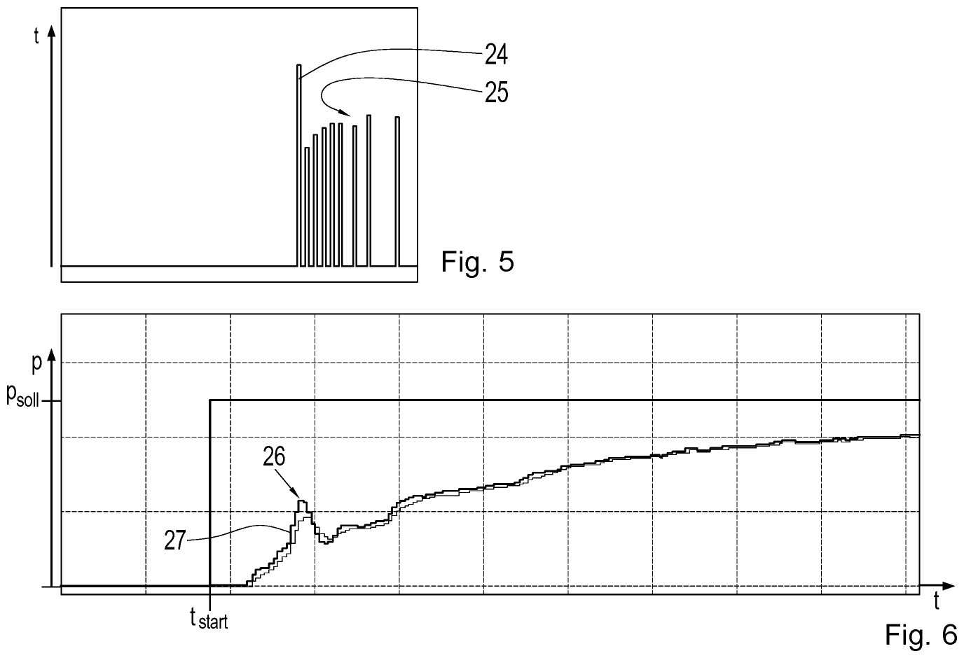

FIG. 5 shows that a first inlet valve pulse 24 lasts longer than the next inlet valve pulse 25, which are not changed. For that purpose, when the inlet valve 20a is moved to its open condition for the first pulse 24 for the first time within the reaction interval Δt, it remains open for a longer time than it does for the pulse 25 that comes immediately after it (particularly in the example embodiment shown) and the corresponding subsequent opening times. The electronic control unit 17 can direct the trailer control valve system 10 to do that. This results in a very small peak 26 in the time variation of the pneumatic braking pressure pₐᵤₛ as shows by a third graph 27. FIG. 6 shows that the first pulse 24 within the reaction interval Δt results in a very small pressure peak 26 at the beginning of the pressure increase. That peak 26 is small enough not to overshoot the desired service brake pressure pₛₒₗₗ. Instead, the pressure peak signals to the control unit software within the reaction interval Δt that the actual-pressure sensor is not stuck at 0 bar, but is capable of providing correct values.

Moreover, the scope of diagnosis can be increased still more. The above-described plausibility check is carried out during a braking demand by the driver. This leads to a high degree of diagnostic cover, but a system-fault or sensor-defect function is only recognized at the beginning of the braking process. To alert the driver to a reduced performance level, it can be helpful to check the correct functioning, in particular of the actual-pressure sensor 13, already before the braking. Since the aforesaid pressure peak can be very small (for example 100 mbar), it is possible to trigger a single high inlet valve pulse even when no braking demand has been made. For that purpose, the inlet valve 20a is moved to the open condition just once while no braking process is being carried out. In that way a further pressure peak (not shown) is produced in the time variation of the pneumatic braking pressure, while no braking process is being carried out. The inlet valve pulse can in particular be followed by an outlet valve pulse, so that the brief pressure rise has no effect upon the braking pressure pₐᵤₛ of the trailer 2, although it is still possible to see a value at the actual-pressure sensor 13. In that case the actual-pressure sensor 13 can be classified as “OK” and the system 8 remains in normal operation. For this, the inlet valve 20a can be moved to a closed condition after it has previously been moved just once to the open condition. Thereafter, in particular a very short time later, the outlet valve 20b can be moved just once to an open condition while no braking process is being carried out. In that way, the pressure peak produced by opening the inlet valve 20a just once can be counteracted.

### INDEXES

pₐᵤₛ Pneumatic braking pressure
pᵢₛₜ Actual braking pressure value
pₘᵢₙ Pneumatic threshold value
pᵣₑ Reaction pressure in the second graph
pᵣₑ₁ First reaction pressure in the first graph
pᵣₑ₂ Second reaction pressure in the first graph
pᵣₑ₃ Third reaction pressure in the first graph
pₛₜₐᵣₜ Pneumatic starting pressure
pₛₒₗₗ Desired service brake pressure
Δt Reaction interval
tₛₜₐᵣₜ Starting time
tₘₐₓ End time
1 Motor vehicle
2 Trailer
3 Motor
4 Wheel
5 Trailer coupling
6 Wheel
7 Trailer brake system
8 Motor vehicle brake system
9 Compressed-air line
10 Trailer control valve system
11 Pressure outlet
12 Measurement line
13 Actual-pressure sensor
14 Foot pedal
15 Foot-brake valve
16 Required-pressure sensor 16
17 Electronic control unit
18 First control circuit
19 Second control circuit
20a Inlet valve
20b Outlet valve
21 Braking characteristic diagram
22 First graph
23 Second graph
24 First pulse
25 Subsequent pulses
26 Pressure peak
27 Third graph
100 First process step
200 Second process step
300 Third process step
400 Fourth process step
500 Fifth process step
600 Sixth process step
600a 1st alternative process step
600b 2nd alternative process step

1. A method for checking an actual-pressure sensor (13) of a motor vehicle brake system (8), the said method comprising:
(100): establishing a duration of a reaction interval (Δt);
(200): establishing a threshold value (pₘᵢₙ);
(300) operating a motor vehicle brake system (8) of a motor vehicle (1) in an electronic braking mode, wherein the motor vehicle brake system (8) delivers a braking pressure (pₐᵤₛ) to a trailer (2) connected to the motor vehicle (1), so that a trailer brake system (7) of the trailer (2) can be actuated by means of the braking pressure (pₐᵤₛ);
(400): starting the reaction interval (Δt) at the beginning of a braking process and measuring pneumatic actual braking pressure values (pᵢₛₜ) by means of an actual-pressure sensor (13), wherein a starting braking pressure (pₛₜₐᵣₜ) of the motor vehicle brake system (8) is measured by the actual-pressure sensor (13) at the beginning of the braking process which is carried out in the electronic braking mode for the trailer (2);
(500): measuring pneumatic reaction braking pressures (pᵣₑ; pᵣₑ₁, pᵣₑ₂, pᵣₑ₃) within the reaction interval (Δt) by means of the actual-pressure sensor (13);
(600): checking whether the reaction braking pressures (pᵣₑ; pᵣₑ₁, pᵣₑ₂, pᵣₑ₃) exceed the threshold value (pₘᵢₙ); and
(600a): continuing the operation of the motor vehicle brake system (8) in the electronic operating mode when at least one measured reaction braking pressure (pᵣₑ₃) exceeds the threshold value (pₘᵢₙ), or (600b): discontinuing the operation of the motor vehicle brake system (8) in the electronic operating mode when none of the measured reaction braking pressures (pre) exceeds the threshold value (pₘᵢₙ).

2. The method according to claim 1, wherein the process steps (400) to (600) are carried out for every braking process initiated when the motor vehicle brake system (8) is operated in the electronic braking mode.

3. The method according to claim 1, wherein the process steps (500) and (600) are only carried out when, in process step (400), the value 0 bar is measured as the starting braking pressure (pₛₜₐᵣₜ).

4. The method according to claim 1, comprising:
determining a target value (pₛₒₗₗ) for the braking pressure (pₐᵤₛ), the target value (pₛₒₗₗ) not in excess of 1 bar; and
regulating the braking pressure (pₐᵤₛ) on the basis of the target value (pₛₒₗₗ) for the braking pressure (pₐᵤₛ) and on the basis of the actual braking pressure values (pᵢₛₜ) measured by the actual-pressure sensor (13).

5. The method according to claim 4, wherein the threshold value (pₘᵢₙ) is set at a value between 0 bar and the target value (pₛₒₗₗ) of the braking pressure.

6. The method according to claim 1, wherein the reaction interval (Δt) is set to a duration of 50 milliseconds to 300 milliseconds.

7. The method according to claim 1, wherein the motor vehicle (1) comprises a trailer control valve system (10) with an inlet valve (20a), and the method comprises moving the inlet valve (20a) to an open condition at least once within the reaction interval (Δt) in order to increase the braking pressure (pₐᵤₛ) of the motor vehicle brake system (8) in such manner that the reaction braking pressures (pᵣₑ₃) exceed the threshold value (ₘᵢₙ).

8. The method according to claim 7, wherein
within the reaction interval (Δt) the inlet valve (20a) is moved to the open condition several times, and
moving the inlet valve (20a) to the open condition for a first time includes holding open the inlet valve (20a) for a longer time than when subsequently moving the inlet valve to the open condition again after the first time.

9. The method according to claim 8, comprising moving the inlet valve (20a) to the open condition while no braking process is being carried out, so that a pressure peak (26) occurs in the time variation (27) of the braking pressure (pₐᵤₛ) while no braking operation is in progress.

10. The method according to claim 9, wherein the trailer control valve system (10) comprises an outlet valve (20b), and the method comprises moving the inlet valve (20a) to a closed condition after the inlet valve has previously been moved to the open condition, and the outlet valve (20b) is then moved once to the open condition while no braking operation is in progress, so that the pressure peak (26) is counteracted.

11. A motor vehicle (1) comprising a motor vehicle brake system (8) with an electronic control unit (17), wherein
the motor vehicle brake system (8) is configured to be operated in an electronic braking mode, and the motor vehicle brake system (8) delivers to the trailer (2) connected to the motor vehicle (1) a braking pressure so that a trailer brake system (7) can be actuated by virtue of the said braking pressure, and
the electronic control unit (17) is configured to carry out the process steps (400) to (600) in accordance with the method according to claim 1.

12. The method according to claim 7, comprising moving the inlet valve (20a) to the open condition while no braking process is being carried out, so that a pressure peak (26) occurs in the time variation (27) of the braking pressure (pₐᵤₛ) while no braking operation is in progress.

13. The method according to claim 12, wherein the trailer control valve system (10) comprises an outlet valve (20b), and the method comprises moving the inlet valve (20a) to a closed condition after the inlet valve has previously been moved to the open condition, and the outlet valve (20b) is then moved once to its open condition while no braking operation is in progress, so that the pressure peak (26) is counteracted.
